(19) United States
(12) Patent Application Publication
(10) Pub. No.: US 2021/0213785 A1
(43) Pub. Date: Jul. 15, 2021

(54) TIRE

(71) Applicant: Sumitomo Rubber Industries, Ltd., Kobe-shi (JP)

(72) Inventor: Koichi NAKAJIMA, Kobe-shi (JP)

(73) Assignee: Sumitomo Rubber Industries, Ltd., Kobe-shi (JP)

(21) Appl. No.: 17/142,265

(22) Filed: Jan. 6, 2021

(30) Foreign Application Priority Data
Jan. 10, 2020 (JP) 2020-003006

(51) Int. Cl. B60C 11/03

(52) U.S. Cl. CPC B60C 11/0306; B60C 2011/0353; B60C 2011/0346

(57) ABSTRACT

A tire can comprise blocks demarcated by a tread groove, in a tread surface thereof, that can include serrated-edged blocks adjacent to each other via the tread groove where the serrated-edged blocks can each include inclined block wall surfaces inclined relative to a tire circumferential direction and a tire axial direction. At least one of the inclined block wall surfaces can have a saw blade-shaped serrated edge portion in which first surface elements extending at an angle θ1 of 2 degrees or less relative to the tire circumferential direction, and second surface elements extending at an angle θ2 of 15 degrees or less relative to the tire axial direction are alternately repeated. The serrated edge portion of one of the serrated-edged blocks adjacent to each other via the tread groove can be provided so as to be opposed to the serrated edge portion of the other of the serrated-edged blocks.

### CROSS REFERENCE TO RELATED APPLICATION(S)

The present application claims priority to Japanese patent application JP 2020-003006, filed on Jan. 10, 2020, the entire contents of which is incorporated herein by reference in its entirety.

### BACKGROUND

### Technical Field

The present disclosure relates to a tire having improved traction performance on a rough terrain road surface.

### Description of the Background Art

For a tire used for a four-wheel-drive vehicle or the like, a tread pattern provided with a plurality of blocks in a tread surface is used in order to improve running performance on a rough terrain road surface.

For example, Japanese Laid-Open Patent Publication No. 2016-43895 describes a tread pattern including blocks having block wall surfaces inclined in a tire circumferential direction and a tire axial direction. In the tread pattern, the block wall surfaces are inclined by forming circumferential grooves continuously extending in the tire circumferential direction as zigzag grooves and forming lateral grooves connecting the circumferential grooves as inclined grooves.

In the above tread pattern, since the lateral grooves are formed as inclined grooves, the impact sound generated at the time of coming into contact with the ground is reduced. In addition, since the circumferential grooves are formed as zigzag grooves, traction performance on a rough terrain road surface may be improved as compared to straight grooves.

However, in the tread pattern, dirt removal performance may be problematic at the lateral grooves (inclined grooves) and the circumferential grooves (zigzag grooves), so that there is a problem that it is difficult to sufficiently exhibit traction performance.

The present disclosure has been made in view of the aforementioned and other problems and an aspect of the present disclosure is to provide a tire capable of enhancing dirt removal performance particularly in grooves and having improved traction performance on a rough terrain road surface.

### SUMMARY

The present disclosure is directed to a tire that can include a plurality of blocks demarcated by a tread groove, in a tread surface thereof, wherein the plurality of blocks can include serrated-edged blocks adjacent to each other via the tread groove, the serrated-edged blocks can each include inclined block wall surfaces inclined relative to a tire circumferential direction and a tire axial direction, at least one of the inclined block wall surfaces can have a saw blade-shaped serrated edge portion in which first surface elements extending at an angle θ1 of 2 degrees or less relative to the tire circumferential direction, and second surface elements extending at an angle θ2 of 15 degrees or less relative to the tire axial direction are alternately repeated, and the serrated edge portion of one of the serrated-edged blocks adjacent to each other via the tread groove can be provided so as to be opposed to the serrated edge portion of the other of the serrated-edged blocks.

### BRIEF DESCRIPTION OF THE DRAWINGS

FIG. 1 is a development of a tread surface of a tire according to one or more embodiments of the present disclosure;

FIG. 2 is an enlarged view showing a part of the tread surface of FIG. 1:

FIG. 3 is an enlarged view exaggeratedly showing a part A in FIG. 2:

FIGS. 4A to 4D are conceptual diagrams for describing an effect of serrated edge portions on an inclined circumferential groove,

FIGS. 5A to 5D are conceptual diagrams for describing an effect of serrated edge portions on an inclined lateral groove; and

FIG. 6 is an enlarged view showing areas of saw blade-shaped projection portions of the serrated edge portions and the groove area of a tread groove.

### DESCRIPTION OF EMBODIMENTS

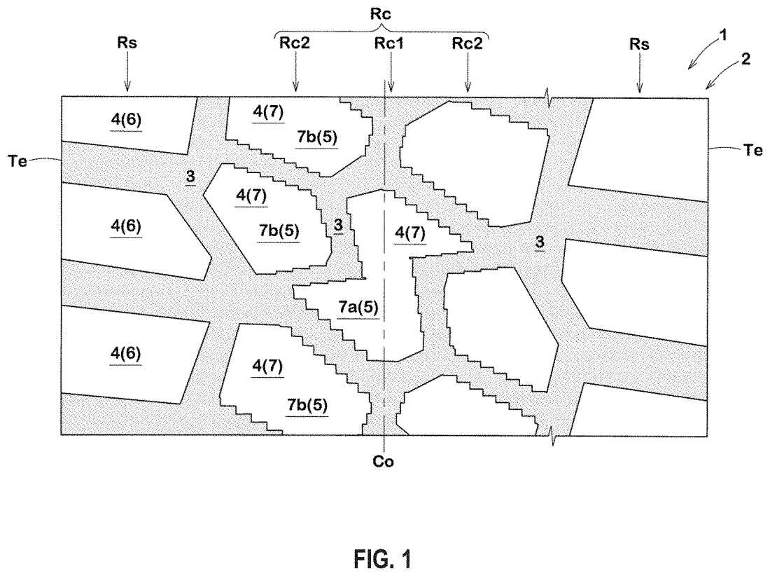

Hereinafter, an embodiment of the present disclosure will be described. As shown in FIG. 1, a tire 1 according to the present embodiment can include a plurality of blocks 4 demarcated by a tread groove 3, in a tread surface 2. The plurality of blocks 4 can include serrated-edged blocks 5 adjacent to each other in the tire circumferential direction and/or the tire axial direction via the tread groove 3. Each serrated-edge block 5 may have one or more edges (including all) that are serrated. Moreover, serrated can mean a saw blade-shape, as an example.

In this example, the plurality of blocks 4 can include shoulder blocks 6 forming a shoulder block row Rs disposed on each outermost side in the tire axial direction, and crown blocks 7 forming a crown block row Rc disposed between the shoulder block rows Rs. In this example, the crown blocks 7 are formed as the serrated-edged blocks 5.

Specifically, the crown block row Rc of this example can include: a center row Rc1 including one or more central crown blocks 7a disposed on a tire equator Co; and outer rows Rc2 including side crown blocks 7b disposed on both sides of the center row Rc1. The central crown blocks 7a and the side crown blocks 7b can each formed as the serrated-edged block 5.

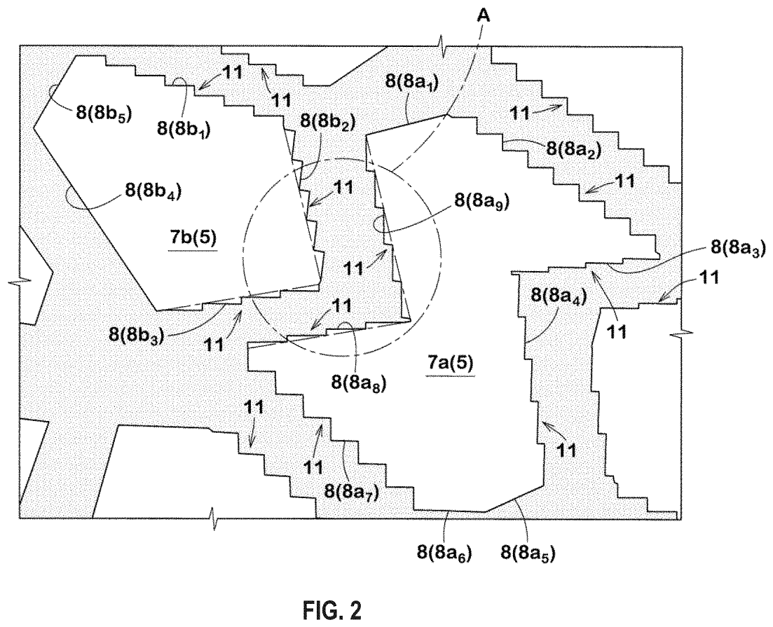

FIG. 2 is an enlarged view showing a part of the tread surface 2 of FIG. 1. FIG. 2 shows a side crown block 7b and a central crown block 7a as representatives. As shown in FIG. 2, the side crown block 7b, which is the serrated-edged block 5, has inclined block wall surfaces 8 that are inclined relative to the tire circumferential direction and the tire axial direction. In this example, the case where all the block wall surfaces surrounding the side crown block 7b are inclined block wall surfaces 8 is shown. However, the block wall surfaces may include non-inclined block wall surfaces.

The phrase “inclined relative to the tire circumferential direction and the tire axial direction” can mean a state where the angle of the block wall surface relative to the tire circumferential direction is in a range of greater than 0 degrees and less than 90 degrees, in other words, the angle of the block wall surface relative to the tire axial direction is in a range of less than 90 degrees and greater than 0 degrees. A block wall surface having an angle of 0 degrees relative to the tire circumferential direction (corresponding to an angle of 90 degrees relative to the tire axial direction) and an angle of 90 degrees relative to the tire circumferential direction (corresponding to an angle of 0 degrees relative to the tire axial direction) may be referred to as the non-inclined block wall surface.

The side crown block 7b of this example has a pentagonal shape, and first to fifth inclined block wall surfaces 8b₁ to 8b₅ are provided as the inclined block wall surfaces 8.

For example, the first inclined block wall surface 8b₁ faces one side in the tire circumferential direction (upper side in FIG. 2). The third inclined block wall surface 8b₃ faces the other side in the tire circumferential direction (lower side in FIG. 2). The second inclined block wall surface 8b₂ connects the first and third inclined block wall surfaces 8b₁ and 8b₃ on one side in the tire axial direction (right side in FIG. 2). In addition, the fourth and fifth inclined block wall surfaces 8b₄ and 8b₅ connect the first and third inclined block wall surfaces 8b₁ and 8b₃ on the other side in the tire axial direction (left side in FIG. 2).

A saw blade-shaped serrated edge portion 11 can be provided to at least one of the first to fifth inclined block wall surfaces 8b₁ to 8b₅, to the first to third inclined block wall surfaces 8b₁ to 8b₃ in this example.

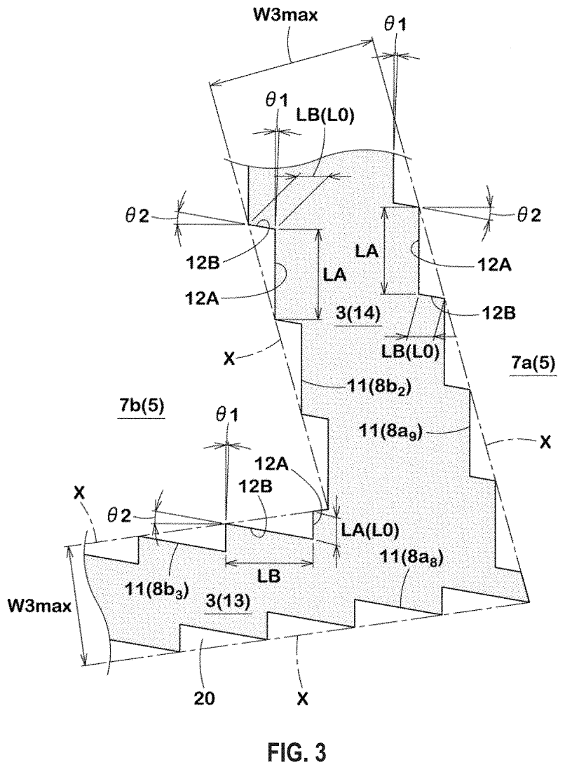

FIG. 3 exaggeratedly shows a part A in FIG. 2. As shown in FIG. 3, each serrated edge portion 11 can be formed as a saw blade-shaped bent surface in which first surface elements 12A extending at an angle θ1 of 2 degrees or less relative to the tire circumferential direction and second surface elements 12B extending at an angle θ2 of 15 degrees or less relative to the tire axial direction are alternately repeated.

In this example, the case where the serrated edge portion 11 is formed over the entirety of each of the first to third inclined block wall surfaces 8b₁ to 8b₃ is shown. However, the serrated edge portion 11 may be partially formed therein.

Moreover, the serrated edge portion 11 of one of the serrated-edged blocks 5 adjacent to each other via the tread groove 3 can be provided so as to be opposed to the serrated edge portion 11 of the other of the serrated-edged blocks 5.

As shown in FIG. 3, the side crown block 7b and the central crown block 7a can be disposed so as to be adjacent to each other via the tread groove 3. The serrated edge portion 11 of the second inclined block wall surface 8b₂ of the side crown block 7b and the serrated edge portion 11 of a ninth inclined block wall surface 8a9 of the central crown block 7a also can be provided so as to be opposed to each other. Similarly, the serrated edge portion 11 of the third inclined block wall surface 8b₃ of the side crown block 7b and the serrated edge portion 11 of an eighth inclined block wall surface 8aa of the central crown block 7a can be provided so as to be opposed to each other.

As shown in FIG. 2, in this example, the central crown block 7a can have an inverted Z shape and can include inclined block wall surfaces 8 that are first to ninth inclined block wall surfaces 8a₁ to 8a₉. Among the first to ninth inclined block wall surfaces 8a₁ to 8a₉, a serrated edge portion 11 can be provided to each of the second to fourth inclined block wall surfaces 8a₂ to 8a₄ and the seventh to ninth inclined block wall surfaces 8a₇ to 8a₉.

As shown in FIG. 3, the first surface elements 12A of one of the serrated edge portions 11 opposed to each other and the first surface elements 12A of the other of the serrated edge portions 11 can be preferably parallel to each other. In addition, the second surface elements 12B of one of the serrated edge portions 11 opposed to each other and the second surface elements 12B of the other of the serrated edge portions 11 can be preferably parallel to each other.

As for the serrated edge portions 11 opposed to each other, a groove wall reference line X of one of the serrated edge portions 11 and a groove wall reference line X of the other of the serrated edge portions 11 can be parallel to each other.

The “groove wall reference line X” can be defined as a line extending along a groove width center line at the position at which the groove width of the tread groove 3 located between the serrated edge portions 11 opposed to each other is the largest. The distance between the groove wall reference lines X can correspond to the maximum groove width W3max of the tread groove 3.

The length LA in the tire circumferential direction of each first surface element 12A of one of the serrated edge portions 11 opposed to each other and the length LA in the tire circumferential direction of each first surface element 12A of the other of the serrated edge portions 11 can be equal to each other. In addition, the length LB in the tire axial direction of each second surface element 12B of one of the serrated edge portions 11 opposed to each other and the length LB in the tire axial direction of each second surface element 12B of the other of the serrated edge portions 11 can be equal to each other.

In one serrated-edged block 5, the lengths LA and LB of the first and second surface elements 12A and 12B may be different for each serrated edge portion 11. That is, for example, the lengths LA and LB of the first and second surface elements 12A and 12B of the serrated edge portion 11 in the second inclined block wall surface 8b₂ may be different from the lengths LA and LB of the first and second surface elements 12A and 12B of the serrated edge portion 11 in the third inclined block wall surface 8b₃.

In the serrated edge portions 11 opposed to each other, a smaller length LO out of the length LA of each first surface element 12A and the length LB of each second surface element 12B can be preferably 8 to 40% of the maximum groove width W3max of the tread groove 3 located between the serrated edge portions 11 opposed to each other.

Next, the effect of the serrated edge portions 11 will be described. As representatively shown in FIG. 3, for convenience, of the tread groove 3, a tread groove having a groove width center line with an angle of greater than 0 degrees and less than 45 degrees relative to the tire axial direction can be referred to as an inclined lateral groove 13, and a tread groove having a groove width center line with an angle of equal to or greater than 45 degrees and less than 90 degrees relative to the tire axial direction can be referred to as an inclined circumferential groove 14.

In the tire 1, in the case where the tread groove 3 located between the serrated edge portions 11 opposed to each other is the inclined circumferential groove 14, the second surface elements 12B can extend at an angle θ2 of 15 degrees or less relative to the tire axial direction. Thus, a higher effect (edge effect) of scratching a road surface in the tire circumferential direction can be exhibited than in the case of a smooth slope having no serrated edge portion 11.

Also in the case where the tread groove 3 located between the serrated edge portions 11 opposed to each other is the inclined lateral groove 13, the same effect can be exhibited. However, since the inclined lateral groove 13 itself can have a smaller angle relative to the tire axial direction, the effect of scratching a road surface in the tire circumferential direction can be relatively high. Thus, the effect of improving traction by the serrated edge portions 11 may be smaller than that in the case of the inclined circumferential groove 14, but can still be exhibited. Moreover, the serrated edge portions 11 can improve the dirt removal performance of the tread groove 3.

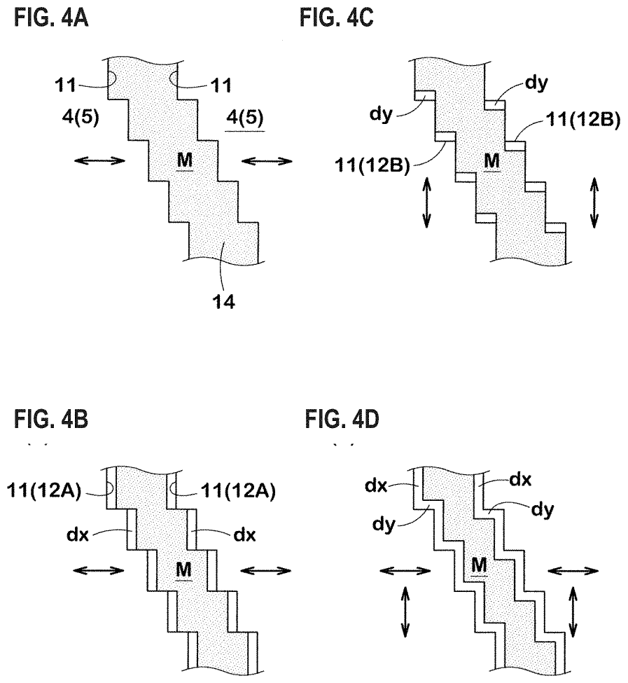

FIGS. 4A to 4D exaggeratedly show a mechanism for improvement of the dirt removal performance by the serrated edge portions 11 in the case where the inclined circumferential groove 14 is provided between the serrated edge portions 11 opposed to each other.

In the tire 1, deformation in the tire axial direction and the tire circumferential direction of the blocks 4 including the serrated-edged blocks 5 is repeated due to contact/non-contact with respect to the ground during running. As shown in FIG. 4B, earthen material (e.g., dirt, mud M) (shown in FIG. 4A) packed between the serrated edge portions 11 can be pushed by the first surface elements 12A due to repeated deformation in the tire axial direction, so that gaps dx are formed in the tire axial direction between the mud M and the serrated edge portions 11. Similarly, as shown in FIG. 4C, the mud M can be pushed by the second surface elements 12B due to repeated deformation in the tire circumferential direction, so that gaps dy are formed in the tire circumferential direction between the mud M and the serrated edge portions 11. That is, as shown in FIG. 4D, the gaps dx and dy can be formed between the mud M and the serrated edge portions 11 due to the repeated deformation in the tire axial direction and the tire circumferential direction, so that the mud M may be easily separated from the serrated edge portions 11. As a result, the dirt removal performance can be enhanced.

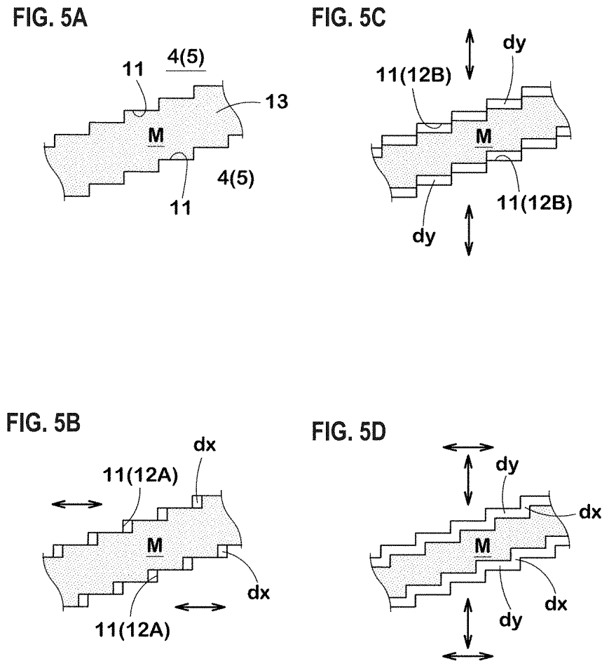

FIGS. 5A to 5D exaggeratedly show a mechanism for improvement of the dirt removal performance by the serrated edge portions 11 in the case where the inclined lateral groove 13 is provided between the serrated edge portions 11 opposed to each other.

As shown in FIG. 5B, earthen material (e.g., dirt, mud M) (shown in FIG. 5A) packed between the serrated edge portions 11 can be pushed by the first surface elements 12A due to repeated deformation in the tire axial direction, so that gaps dx are formed in the tire axial direction between the mud M and the serrated edge portions 11. Similarly, as shown in FIG. 5C, the mud M can be pushed by the second surface elements 12B due to repeated deformation in the tire circumferential direction, so that gaps dy are formed in the tire circumferential direction between the mud M and the serrated edge portions 11. That is, as shown in FIG. 5D, the gaps dx and dy can be formed between the mud M and the serrated edge portions 11 due to the repeated deformation in the tire axial direction and the tire circumferential direction, so that the mud M may be easily separated from the serrated edge portions 11. As a result, the dirt removal performance can be enhanced.

The angle θ1 of each first surface element 12A may not exceed 2 degrees, and the angle θ2 of each second surface element 12B may not exceed 15 degrees. The range of the angle θ1 can be preferably equal to or less than 1 degree and includes 0 degrees. As for the direction of inclination of the first surface element 12A relative to the tire circumferential direction, the first surface element 12A may be inclined to either one side or the other side in the tire axial direction. The range of the angle θ2 can be preferably equal to or less than 12 degrees, further preferably equal to or less than 8 degrees, and particularly preferably equal to or less than 5 degrees, and includes 0 degrees. As for the direction of inclination of the second surface element 12B relative to the tire axial direction, the second surface element 12B may be inclined to either one side or the other side in the tire circumferential direction.

According to one or more embodiments, the smaller length LO out of the length LA of each first surface element 12A and the length LB of each second surface element 12B may not be less than 8% of the maximum groove width W3max.

At the inclined circumferential groove 14, the length LB of each second surface element 12B can correspond to the smaller length LO. At the inclined lateral groove 13, the length LA of each first surface element 12A can correspond to the smaller length LO. According to one or more embodiments, the smaller length LO may not be less than 8% of the maximum groove width W3max. On the other hand, the smaller length LO may not exceed 40% of the maximum groove width W3max.

From such a viewpoint, the lower limit of the smaller length LO can be preferably equal to or greater than 10% and more preferably equal to or greater than 15% of the maximum groove width W3max, and the upper limit of the smaller length LO can be preferably equal to or less than 35% and more preferably equal to or less than 30% of the maximum groove width W3max.

Each saw blade-shaped projection portion 20 can be defined as a portion projecting from the groove wall reference line X in the serrated edge portion 11.

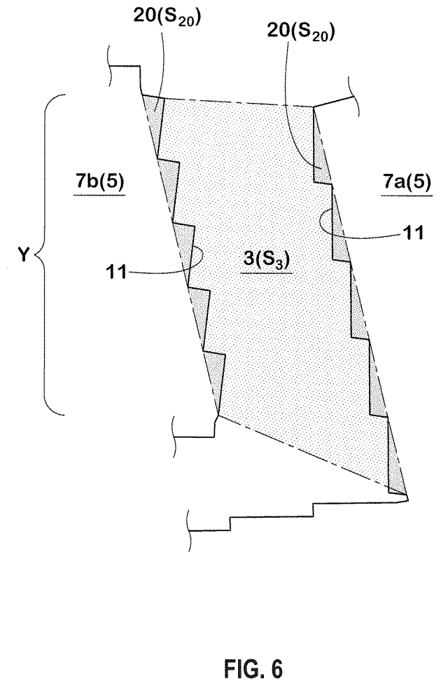

As shown in FIG. 6, in a region range Y between the serrated edge portions 11 opposed to each other, the total sum ΣS20 of areas S20 in a plan view of the saw blade-shaped projection portions 20 can be preferably 20 to 30% of a groove area S3 in a plan view of the tread groove 3.

The tread groove 3 can be less likely to be clogged with mud when the groove width of the tread groove 3 is larger. This is because, as the groove width is larger, the mud in the groove may more easily move and the adhesion of the mud to the block wall surface decreases, and the mud itself may become heavier. Therefore, the serrated edge portions 11 can more effectively work particularly when the groove width of the tread groove 3 is as small as 30 mm or less. In other words, in the tire 1, the maximum groove width W3max of the tread groove 3 located between the serrated edge portions 11 opposed to each other can be preferably equal to or less than 30 mm and further preferably equal to or less than 25 mm.

As shown in FIG. 1, in each shoulder block row Rs, mud in the tread groove 3 can be easily discharged from a tread end Te to the outside of the tire 1, so that the dirt removal performance is sufficient. Therefore, in this example, the serrated edge portions 11 can be provided only to the crown blocks 7. However, if required, serrated edge portions 11 may be provided to the shoulder blocks 6.

The effect of improving traction by the serrated edge portions 11 can be effectively exhibited even on a snowy road surface.

Although the particularly preferred embodiments of the present disclosure have been described in detail above, the present disclosure is not limited to the embodiments shown in the drawings, and various modifications can be made to implement the present disclosure.

### EXAMPLES

In order to confirm the advantageous effects of the present disclosure, pneumatic tires (size: 35×12.50R20) having the tread pattern shown in FIG. 1 as a basic pattern were produced as test tires on the basis of specifications in Table 1. The respective test tires were tested for traction performance on a rough terrain road surface. A comparative example is different from the Examples only in including no serrated edge portions.

In each Example, the angle θ1 of each first surface element of each serrated edge portion was 2 degrees, and the angle θ2 of each second surface element of each serrated edge portion was 15 degrees. In addition, in each Example, the ratio ΣS20/S3 of the total sum ΣS20 of the areas in a plan view of the saw blade-shaped projection portions to the groove area in a plan view of the tread groove was different for each pair of serrated edge portions opposed to each other, but each ratio ΣS20/S3 was in a range of 20 to 30%.

<Traction Performance>

The tires were mounted to all the wheels of a four-wheel-drive vehicle (jeep) under the condition of internal pressure (260 kPa), one driver got in the vehicle and drove the vehicle on a test course having a rough terrain road surface, and sensory evaluation was made by the driver for traction performance. In the evaluation, a score was given with the result of the comparative example being regarded as 100. A higher value indicates that the result is better.

TABLE 1

| | Comparative | | | | | | |
|---|---|---|---|---|---|---|---|
| | Example | Example 1 | Example 2 | Example 3 | Example 4 | Example 5 | Example 6 |
| Presence/absence of | Absence | Presence | | | | | |
| serrated edge portions | | | | | | | |
| Ratio (L0/W3max) at | — | 7% | 8% | 15% | 30% | 40% | 45% |
| inclined circumferential | | | | | | | |
| groove | | | | | | | |
| Ratio (L0/W3max) at | — | 7% | 8% | 15% | 20% | 40% | 45% |
| inclined lateral groove | | | | | | | |
| Traction performance | 100 | 101 | 103 | 105 | 110 | 103 | 101 |

As shown in the table, it was confirmed that, in the Examples, the traction performance was improved by providing serrated edge portions.

In the tire according to the present disclosure, the first and second surface elements of one of the serrated edge portions opposed to each other and the first and second surface elements of the other of the serrated edge portions can be parallel to each other.

In the tire according to the present disclosure, a smaller length out of a length LA in the tire circumferential direction of each first surface element and a length LB in the tire axial direction of each second surface element in the serrated edge portions opposed to each other can be 8 to 40% of a maximum groove width of the tread groove located between the serrated edge portions opposed to each other.

In the tire according to the present disclosure, in a region range between the serrated edge portions opposed to each other, a total sum of areas in a plan view of saw blade-shaped projection portions of the serrated edge portions from groove wall reference lines each defined as a line extending along a groove width center line at a position at which a groove width of the tread groove located between the serrated edge portions opposed to each other is the largest can be 20 to 30% of a groove area in a plan view of the tread groove.

In the tire according to the present disclosure, preferably, the plurality of blocks includes shoulder blocks forming a shoulder block row disposed on each outermost side in the tire axial direction, and crown blocks forming a crown block row disposed between the shoulder block rows, and the crown blocks can be formed as the serrated-edged blocks.

The tire according to the present disclosure can include a plurality of blocks including serrated-edged blocks adjacent to each other via a tread groove, in a tread surface thereof. The serrated-edged blocks can each include inclined block wall surfaces inclined relative to a tire circumferential direction and a tire axial direction.

At least one of the inclined block wall surfaces can have a saw blade-shaped serrated edge portion in which first surface elements extending at an angle θ1 of 2 degrees or less relative to the tire circumferential direction, and second surface elements extending at an angle θ2 of 15 degrees or less relative to the tire axial direction are alternately repeated. Furthermore, the serrated edge portion of one of the serrated-edged blocks adjacent to each other via the tread groove can be provided so as to be opposed to the serrated edge portion of the other of the serrated-edged blocks.

That is, the portion of the tread groove located between the serrated-edged blocks adjacent to each other can form an inclined groove between the inclined block wall surfaces. Thus, in the case where the inclined groove is formed as a lateral groove, an effect of reducing the impact sound generated at the time of coming into contact with the ground can be exhibited. In addition, in the case where the inclined groove is formed as an inclined portion of a circumferential groove (zigzag groove), traction force can be obtained.

Moreover, a serrated edge portion can be provided to each of the inclined block wall surfaces opposed to each other. In the serrated edge portion, since the second surface elements extend at an angle θ2 of 15 degrees or less relative to the tire axial direction, a high effect (edge effect) of scratching a road surface in the tire circumferential direction can be exhibited.

Meanwhile, deformation of the blocks in the tire axial direction and the tire circumferential direction can be repeated due to contact/non-contact with respect to the ground during running. At this time, due to the saw blade-shaped serrated edge portions composed of the first and second surface elements, gaps can be easily formed between the serrated edge portions and mud packed between the serrated edge portions. Therefore, the packed mud can be easily separated from the serrated edge portions, so that dirt removal performance can be enhanced.

The above-described high edge effect and high dirt removal performance can improve traction performance.

What is claimed is:

1. A tire comprising a plurality of blocks demarcated by a tread groove, in a tread surface thereof, wherein
the plurality of blocks includes serrated-edged blocks adjacent to each other via the tread groove,
the serrated-edged blocks each include inclined block wall surfaces inclined relative to a tire circumferential direction and a tire axial direction,
at least one of the inclined block wall surfaces has a saw blade-shaped serrated edge portion in which first surface elements extending at an angle θ1 of 2 degrees or less relative to the tire circumferential direction, and second surface elements extending at an angle θ2 of 15 degrees or less relative to the tire axial direction are alternately repeated, and
the serrated edge portion of one of the serrated-edged blocks adjacent to each other via the tread groove is provided so as to be opposed to the serrated edge portion of the other of the serrated-edged blocks.

2. The tire according to claim 1, wherein the first and second surface elements of one of the serrated edge portions of said one of the serrated-edged blocks and the first and second surface elements of the opposed serrated edge portions of said other of the serrated-edged blocks are respectively parallel to each other.

3. The tire according to claim 1, wherein a smaller length out of a length LA in the tire circumferential direction of each first surface element and a length LB in the tire axial direction of each second surface element in the serrated edge portions opposed to each other is 8 to 40% of a maximum groove width of the tread groove located between the serrated edge portions opposed to each other.

4. The tire according to claim 3, wherein the maximum groove width of the tread groove is equal to or less than 30 mm.

5. The tire according to claim 1, wherein, in a region range between the serrated edge portions opposed to each other, a total sum of areas in a plan view of saw blade-shaped projection portions of the serrated edge portions from groove wall reference lines each defined as a line extending along a groove width center line at a position at which a groove width of the tread groove located between the serrated edge portions opposed to each other is the largest is 20 to 30% of a groove area in a plan view of the tread groove.

6. The tire according to claim 1,
wherein the plurality of blocks includes shoulder blocks forming a shoulder block row disposed on each outermost side in the tire axial direction, and crown blocks forming a crown block row disposed between the shoulder block rows, and
wherein the crown blocks are formed as the serrated-edged blocks.

7. The tire according to claim 2, wherein a smaller length out of a length LA in the tire circumferential direction of each first surface element and a length LB in the tire axial direction of each second surface element in the serrated edge portions opposed to each other is 8 to 40% of a maximum groove width of the tread groove located between the serrated edge portions opposed to each other.

8. The tire according to claim 2, wherein, in a region range between the serrated edge portions opposed to each other, a total sum of areas in a plan view of saw blade-shaped projection portions of the serrated edge portions from groove wall reference lines each defined as a line extending along a groove width center line at a position at which a groove width of the tread groove located between the serrated edge portions opposed to each other is the largest is 20 to 30% of a groove area in a plan view of the tread groove.

9. The tire according to claim 3, wherein, in a region range between the serrated edge portions opposed to each other, a total sum of areas in a plan view of saw blade-shaped projection portions of the serrated edge portions from groove wall reference lines each defined as a line extending along a groove width center line at a position at which a groove width of the tread groove located between the serrated edge portions opposed to each other is the largest is 20 to 30% of a groove area in a plan view of the tread groove.

10. The tire according to claim 7, wherein, in a region range between the serrated edge portions opposed to each other, a total sum of areas in a plan view of saw blade-shaped projection portions of the serrated edge portions from groove wall reference lines each defined as a line extending along a groove width center line at a position at which a groove width of the tread groove located between the serrated edge portions opposed to each other is the largest is 20 to 30% of a groove area in a plan view of the tread groove.

11. The tire according to claim 1, wherein each of the serrated-edged blocks is in the form of an irregular polygon in a plan view of the tread surface.

12. The tire according to claim 11, wherein at least one of the serrated-edged blocks is in the form of an inverted Z shape as the irregular polygon in the plan view of the tread surface.

13. The tire according to claim 1,
wherein the plurality of blocks includes crown blocks forming a plurality of crown block rows in the tire circumferential direction,
wherein the crown blocks that form the plurality of crown block rows are all formed as the serrated-edged blocks, and
wherein each of the serrated-edged blocks is in the form of an irregular polygon in a plan view of the tread surface.

14. The tire according to claim 13, wherein the plurality of crown block rows include a pair of outer crown block rows, respective pairs of the serrated-edged blocks of the outer crown block rows being mirror images of each other relative to a tire equator in a direction angled from the tire axial direction.

15. The tire according to claim 13,
wherein the plurality of crown block rows include a pair of outer crown block rows and a center crown block row between the outer crown block rows,
wherein the serrated-edged blocks of each of the outer crown block rows overlap the serrated-edged blocks of the center crown block row in the tire circumferential direction, and
wherein the serrated-edged blocks of the outer crown block rows do not overlap each other in the tire circumferential direction.

16. The tire according to claim 1, wherein said one of the serrated-edged blocks has an edge portion that is non-serrated opposite said serrated edge portion in which the first surface elements extending at the angle θ1 of 2 degrees or less relative to the tire circumferential direction, and the second surface elements extending at the angle θ2 of 15 degrees or less relative to the tire axial direction are alternately repeated.

17. The tire according to claim 1, wherein a first portion of the tread groove between the serrated edge portion of said one of the serrated-edged blocks adjacent to the serrated edge portion of said other of the serrated-edged blocks is wider than a second portion of the tread groove between said one of the serrated-edged blocks and yet another serrated edge portion different from the serrated edge portions of said one and said another of the serrated-edged blocks.

18. The tire according to claim 1, wherein a first length of the serrated edge portion of said one of the serrated-edged blocks is greater than a second length of the serrated edge portion of said other of the serrated-edged blocks.

19. The tire according to claim 1,
wherein a first length of the serrated edge portion of said one of the serrated-edged blocks is greater than a second length of another serrated edge portion of said one of the serrated-edged blocks, and
wherein the serrated edge portion of said one of the serrated-edged blocks and the another serrated edge portion of said one of the serrated-edged blocks is generally linear.

20. The tire according to claim 1,
wherein the plurality of blocks includes shoulder blocks forming a shoulder block row and crown blocks forming a crown block row in the tire circumferential direction,
wherein the crown blocks that form the plurality of crown block rows are formed as the serrated-edged blocks, and
wherein respective portions of the tread groove are immediately adjacent to and separate the shoulder block row from the crown block row.
